(19) United States
(12) Patent Application Publication
(10) Pub. No.: US 2012/0230194 A1
(43) Pub. Date: Sep. 13, 2012

(54) Hash-Based Load Balancing in Large Multi-Hop Networks with Randomized Seed Selection

(75) Inventors: Brad MATTHEWS, San Jose, CA (US); Puneet Agarwal, Cupertino, CA (US)

(73) Assignee: Broadcom Corporation, Irvine, CA (US)

(21) Appl. No.: 13/417,104

(22) Filed: Mar. 9, 2012

Related U.S. Application Data
(60) Provisional application No. 61/451,924, filed on Mar. 11, 2011.

(51) Int. Cl. H04L 12/24

(52) U.S. Cl. 370/235

(57) ABSTRACT

Methods and apparatus for improving hash-based load balancing with randomized seed selection are disclosed. The methods and apparatus described herein increase the number of unique fields in a hash key before the hash key is presented to a hash function. The methods include selecting one or more seed values based the output of a first arbitrary function having a first set of packet fields as input. The one or more seed values are combined with a second set of packet fields. A second arbitrary function generates a hash value based on the one or more seed values and the second set of packet fields. The hash value is applied as input to a hash function in a member selection module. The method enables per flow randomization attributes based on per packet attributes to perform aggregate member selection while remaining deterministic from a root-node or network perspective.

### CROSS REFERENCE TO RELATED CASES

This application claims the benefit of U.S. Provisional Patent Application No. 61/451,924, filed Mar. 11, 2011 which is incorporated by herein by reference in its entirety.

### FIELD OF THE INVENTION

This application relates generally to improving hash function performance and specifically to improving load balancing in data networks.

### BACKGROUND

In large networks having multiple interconnected devices, traffic between source and destination devices typically traverses multiple hops. In these networks, devices that process and communicate data traffic often implement multiple equal cost paths across which data traffic may be communicated between a source device and a destination device. In certain applications, multiple communications links between two devices in a network may be grouped together (e.g., as a logical trunk or an aggregation group). The data communication links of an aggregation group (referred to as “members”) may be physical links or alternatively virtual (or logical) links.

Aggregation groups may be implemented in a number of fashions. For example, an aggregation group may be implemented using Layer-3 (L3) Equal Cost Multi-Path (ECMP) techniques. Alternatively, an aggregation group may be implemented as a link aggregation group (LAG) in accordance with the IEEE 802.3ad standard. In another embodiment, an aggregation group may be implemented as a Hi-Gig trunk. As would be appreciated by persons of skill in the art, other techniques for implementing an aggregation group may be used.

In applications using multiple paths between devices, traffic distribution across members of the aggregate group must be as even as possible to maximize throughput. Network devices (nodes) may use load balancing techniques to achieve distribution of data traffic across the links of an aggregation group. A key requirement of load balancing for aggregates is that packet order must be preserved for all packets in a flow. Additionally, the techniques used must be deterministic so that packet flow through the network can be traced.

Hash-based load balancing is a common approach used in modern packet switches to distribute flows to members of an aggregate group. To perform such hash-based load balancing across a set of aggregates, a common approach is to hash a set of packet fields to resolve which among a set of possible route choices to select (e.g., which member of an aggregate). At every hop in the network, each node may have more than one possible next-hop/link that will lead to the same destination.

In a network or network device, each node would select a next-hop/link based on a hash of a set of packet fields which do not change for the duration of a flow. A flow may be defined by a number of different parameters, such as source and destination addresses (e.g., IP addresses or MAC addresses), TCP flow parameters, or any set of parameters that are common to a given set of data traffic. Using such an approach, packets within a flow, or set of flows that produce the same hash value, will follow the same path at every hop. Since binding of flows to the next hop/link is fixed, all packets will traverse a path in order and packet sequence is guaranteed. However, this approach leads to poor distribution of multiple flows to aggregate members and causes starvation of nodes, particularly in large multi-hop, multi-path networks (e.g., certain nodes in a multi-hop network may not receive any data traffic), especially as one moves further away from the node (called root node) at which the traffic entered the network.

What is therefore needed are techniques for providing randomization and improved distribution to aggregate members.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a block diagram of a single-hop of a multi-hop network in accordance with an embodiment of the invention.

FIG. 2 illustrates a block diagram of two hops of a multi-path network in accordance with an embodiment of the invention.

FIG. 3 is a block diagram illustrating a network node, in accordance with an embodiment of the present invention.

FIG. 4 is a flowchart illustrating a method for hash-based load balancing in large multi-hop networks with randomized seed selection, according to an embodiment of the present invention.

FIG. 5 illustrates an example computer system 500 in which embodiments of the present invention, or portions thereof, can be implemented as computer-readable code.

The present invention will be described with reference to the accompanying drawings. The drawing in which an element first appears is typically indicated by the leftmost digit(s) in the corresponding reference number.

### DETAILED DESCRIPTION

In the following description, numerous specific details are set forth in order to provide a thorough understanding of the invention. However, it will be apparent to those skilled in the art that the invention, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the invention.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

FIG. 1 is block diagram illustrating a single-hop of a multi-path network 100 (network 100), according to embodiments of the present invention. For purposes of this disclosure, a node may be viewed as any level of granularity in a data network. For example, a node could be an incoming data port, a combination of the incoming data port and an aggregation group, a network device, a packet switch, or may be some other level of granularity. The network 100 includes three nodes, Node 0 105, Node 1 110 and Node 2 115. In the network 100, data traffic (e.g., data packets) may enter the network 100 via Node 0 105 (referred to as the “root” node). Depending on the data traffic, Node 0 105, after receiving the data traffic, may then select a next-hop/link for the data traffic. In this example, the Node 0 105 may decide to send certain data packets to the Node 1 110 and send other data packets to the Node 2 115. These data packets may include data information, voice information, video information or any other type of information.

In a multi-path network, the Node 1 110 and the Node 2 115 may be connected to other nodes in such a fashion that data traffic sent to either node can arrive at the same destination. In such approaches, the process of binding a flow to a next-hop/link may begin by extracting a subset of static fields in a packet header (e.g., Source IP, Destination IP, etc.) to form a hash key. A hash key may map to multiple flows. Typically, the hash key is specific to a single flow and does not change for packets within the flow. If the hash key were to change for packets within a flow, a fixed binding of a flow to a next-hop/link would not be guaranteed and re-ordering of packets in that flow may occur at one or more nodes. Packet re-ordering could lead to degraded performance for some communication protocols (e.g., TCP).

The hash key then serves as an input to a hash function, commonly a CRC16 variant or CRC32 variant, which produces, respectively, a 16-bit or 32-bit hash value. In some implementations, a CRCXX hash function is used. As would be appreciated by a person of ordinary skill in the art, other switches may use different hash functions (e.g., Pearson's hash). Typically, only a subset of the hash value bits is used by a given application (e.g., Trunking, LAGs, and ECMP), herein, collectively, aggregation group(s)). Unused bits of the hash value are masked out and only the masked hash value is used to bind a flow to one of the N aggregate members, where N is the number of links that belong to a given aggregation group.

The list of N aggregate members may be maintained in a destination mapping table for a given aggregate. Each table entry contains forwarding information indicating a link (next hop). The index into the destination mapping table may be calculated as the remainder of the masked hash value modulo N (the number of aggregate group members), such as the one shown below by Equation 1.

destination table index=masked_hash_value mod N (1)

Using the destination table index, the node may determine the next-hop/link destination (aggregate member) for each packet. This process binds a flow or set of flows to a single aggregate member using a mathematical transformation that will always select the same aggregate member for a given hash key at each node.

As discussed above, network 100 is a single-hop network (depth=1 with two layers) that may be part of a larger multi-hop, multi-path network that performs forwarding for flows going to the same or different destinations. As previously indicated, all data traffic that is communicated in the network 100 traffic may enter the network 100 via a root node. For purposes of this example, it will be assumed that all flows can reach any destination of a larger network of which the network 100 is a part of using any leaf of an N-ary tree rooted at the Node 0 105. In such a network, packets originating at the root node will pick between 1 to N aggregate members from which the packet should depart using a hashing function. If each flow has a unique hash key and the hash function distributes hash-values equally over the hash values 16-bit space, then flows arriving to the Node 0 105 will be distributed evenly to each of its two child nodes, Node 1 110 and Node 2 115.

If the depth of the tree is one (as shown in FIG. 1), flows are evenly distributed and there are no starved paths (paths that receive no traffic). Therefore, in this example, neither Node 1 110 or Node 2 115 will receive a disproportionate number of flows and, accordingly, there are no starved leaf nodes (i.e. leaf nodes that receive no traffic).

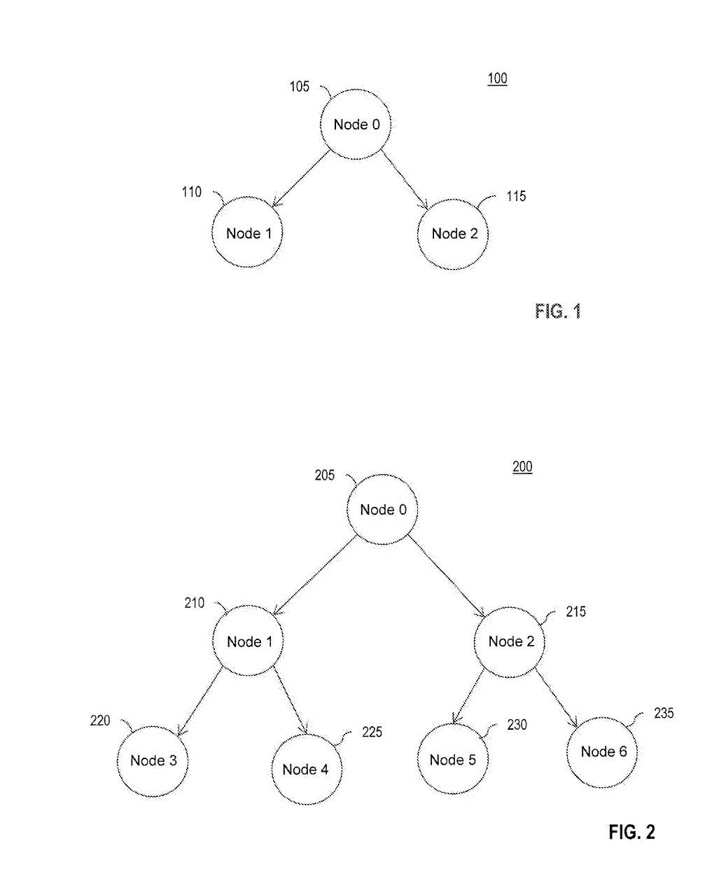

Extending the depth of the tree another level, both node 1 and node 2 have 2 children each. This embodiment is depicted in FIG. 2. FIG. 2 is a block diagram illustrating two hops of a multi-path network 200 in accordance with an example embodiment. As with network 100 discussed above, the network 200 may be part of a larger multi-hop, multi-path network. In network 100, all data traffic that is communicated in the network 200 may enter the network 200 via a single node (called root node), in this case, the Node 0 205.

In the network 200, if the same approach is used to determine hash keys and the same hash function is used for all nodes, an issue arises at the second layer of the network 200 as flows are received at Node 1 210 and Node 2 215. In this situation, each packet arriving at Node 1 210 will yield the same hash key as Node 0 205, when operating on the same subset of packet fields (which is a common approach). Given the same hash function (e.g., a CRC16 hash function) and number of children, the result of the hashing process at Node 0 205 will be replicated at Node 1 210. Consequently, all flows that arrive at Node 1 210 will be sent to Node 3 220 as these are the same flows that went “left” at Node 0 205. Because, in this arrangement, the same mathematical transformation (hash function) is performed on the same inputs (hash keys) at each node in the network, the next-hop/link selected by the hash algorithm remains unchanged at each hop. Thus, the next-hop/link selection between two or more nodes in the flow path (e.g., Node 0 205 and Node 1 210) is highly correlated, which may lead to significant imbalance among nodes.

For a binary tree with a depth of 2 hops (three layers), the consequence of this approach is that all flows that went “left” at the Node 0 205 and arrived at the Node 1 210 (e.g., all flows arriving at the Node 1 210 from Node 0 205), will again go “left” at Node 1 210 and arrive at Node 3 220. As a result, Node 4 225 will not receive any data traffic, thus leaving it starved. Similarly, all traffic sent to the Node 2 215 will be propagated “right” to the Node 6 235, thereby starving the Node 5 230. As the depth of such a network increases, this problem is exacerbated given that the number of leaf nodes increases (e.g., exponentially), but only two nodes at each level will receive data traffic.

As described above, some fields in a received packet may be limited in the amount of unique information they contain. This impacts the distribution of the hash and leads to imbalance in certain scenarios. As a result, the outputs of a hash function using these fields as input are inadequate for many applications such as traffic distribution. The techniques described herein remap one or more of these fields to new values before presenting the hash key to the hash function. These techniques improve hash function performance and improve the uniqueness of hash outputs. As discussed in further detail below, the following techniques, when applied in aggregate member selection, reduce the correlation associated with path selection in a multi-hop network, while also providing some degree of determinism by utilizing configured per-device attributes.

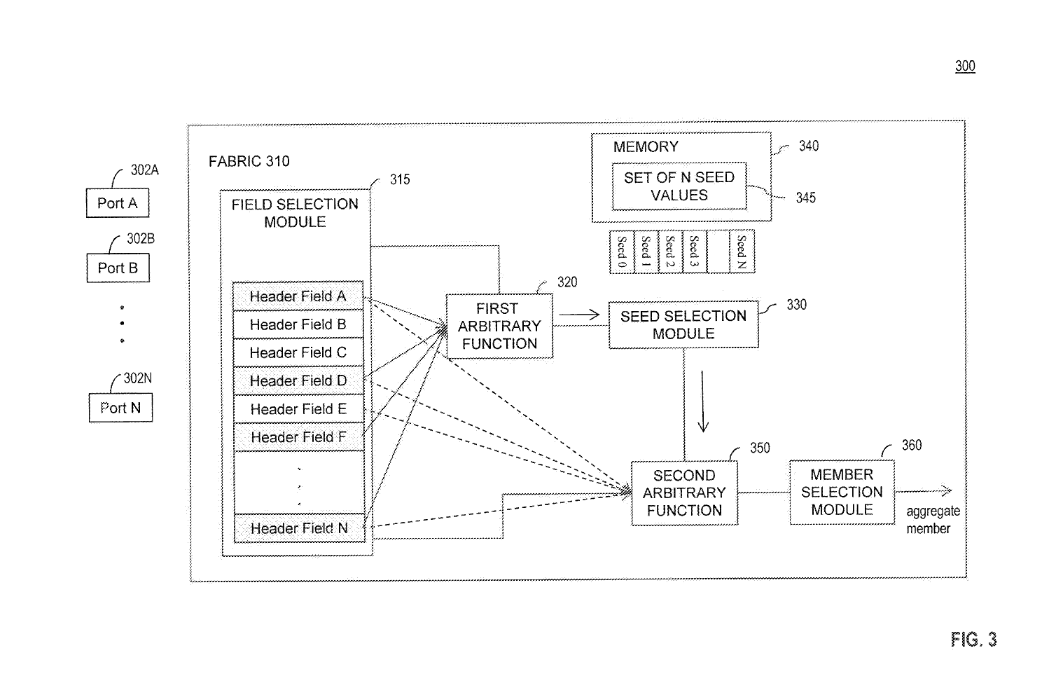

FIG. 3 is a block diagram illustrating a network node 300, in accordance with an embodiment of the present invention. Network node 300 may be a network switch, a router, a network interface card, or other appropriate data communication device. Node 300 may be configured to perform the load balancing techniques described herein.

Node 300 includes a plurality of ports 302A-N (Ports A through N) configured to receive and transmit data packets over a communications link. Node 300 also includes switching fabric 310. Switching fabric 310 is a combination of hardware and software that, for example, switches (routes) incoming data to the next node in the network. In an embodiment, fabric 310 includes one or more processors and memory.

Fabric 310 also includes a memory 340. Memory 340 includes a set of N seed values 345. In an embodiment, the set of N seed values are provided by a user of the node. In an alternative embodiment, the set of N seed values are generated at the node. In embodiments, each node in a network has a different set of N seed values.

Fabric 310 includes a field selection module 315. Field selection module 315 is configured to receive a packet and to select one or more fields from the incoming packet and provide those fields to a first arbitrary function and/or a second arbitrary function. In an embodiment, field selection module 315 provides a different set of packet fields to the second arbitrary function.

First arbitrary function (ƒ₁) module 320 is coupled to field selection module 315. The first arbitrary function module 320 applies a first arbitrary function to the input packet fields. The first arbitrary function may be any arbitrary function such as a CRC (e.g., CRC16, CRC32, or CRCXX), a mapping table, a Fowler/Noll/Vo (FNV) hash, or an XOR hash. The first arbitrary function module 320 is configured to output a seed index.

Seed selection module 330 receives the seed index. Seed selection module 330 is configured to select one or more of the stored set of N seed values based on the received seed index. The output of seed selection module 330 is provided as one input to second arbitrary function (ƒ₂) module 350.

Second arbitrary function (ƒ2) module 350 is coupled to field selection module 315, seed selection module 330 and member selection module 360. The second arbitrary function module 350 receives as input, one or more of the selected seeds and a set of packet fields from the field selection module 315. The second arbitrary function module 350 applies a second arbitrary function to these input fields. The second arbitrary function may be any arbitrary function such as a CRC (e.g., CRC16, CRC32, or CRCXX), a mapping table, a FNV hash, and/or an XOR hash. The second arbitrary function module may output a set of seeds or a hash key as a hash value.

Node 300 may also include a member selection module 360. Member selection module 360 includes a function that maps the input hash value to an aggregate member. The function implemented in member selection module 360 may be any arbitrary function. In an embodiment, the function may be a hash function. In an alternate embodiment, the function is a modulo function.

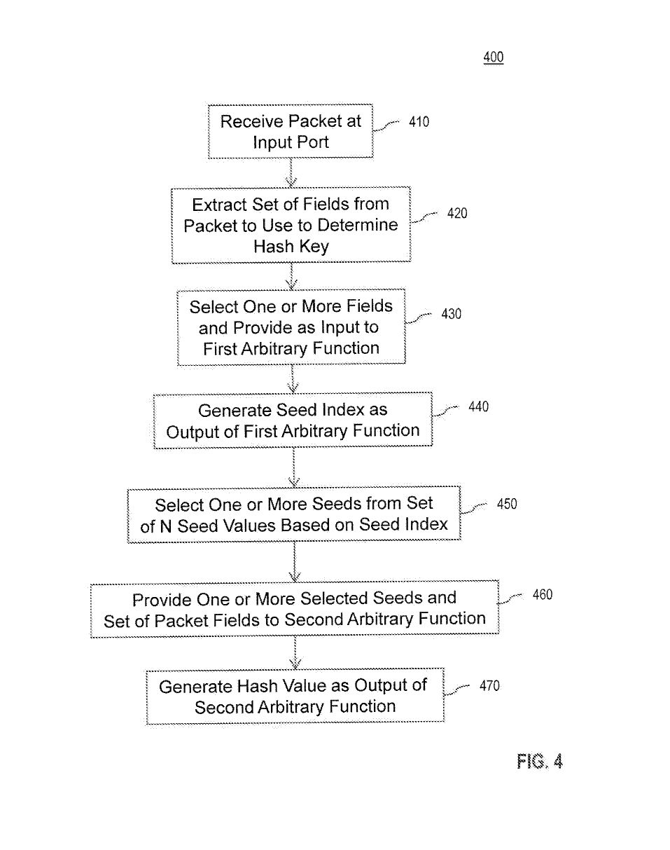

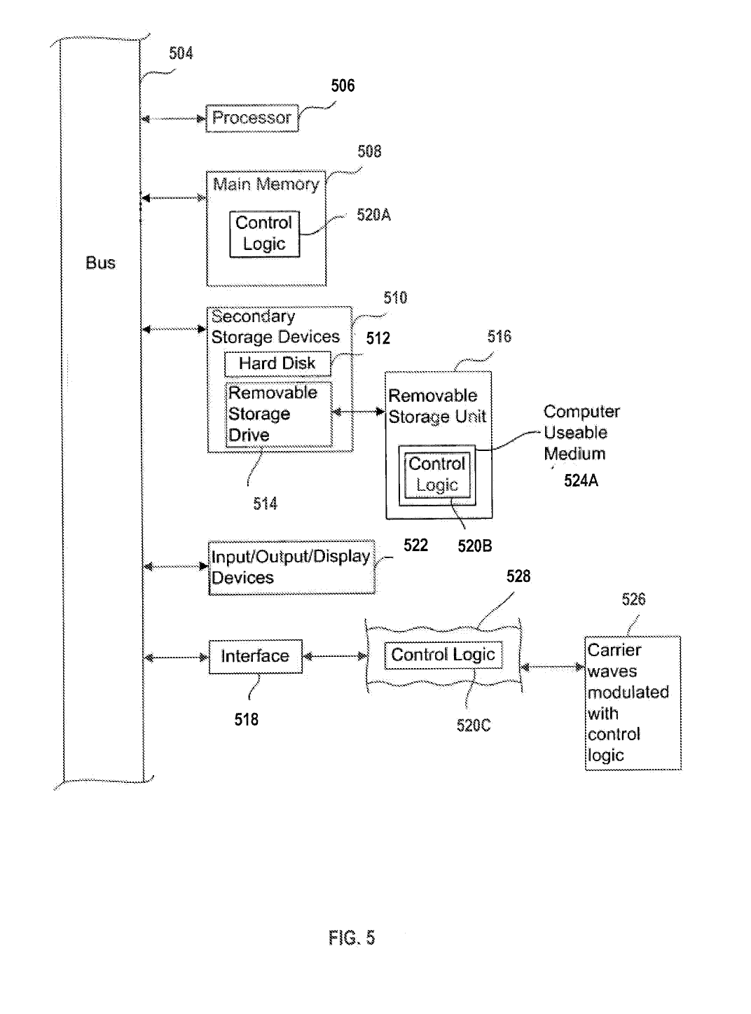

FIG. 4 is a flowchart illustrating a method 400 for hash-based load balancing in large multi-hop networks with randomized seed selection, according to an embodiment of the present invention. As described below, the method adds information to the available packet fields, increasing the number of unique fields available to the arbitrary function. The method 400 may be implemented in the network 100 or the network 200 where any or all of the network nodes may individually implement the method 400. Method 400 is described with reference to the system depicted in FIG. 3. However, method 400 is not limited to the embodiment of FIG. 3.

In step 410, a data packet is received by the node at a port 302. A data packet has a plurality of packet fields. A set of these fields (e.g., source address, destination address) remain fixed for a given data flow (micro-flow or macro-flow). Data in one or more fields in the data packet is or may be different from data in that field in other packets in the flow.

In step 420, one or more fields from the data packet are selected from the received packet and provided as an input to first arbitrary function 320. In an embodiment, the number of fields selected can vary based on the packet type or application. For example, fields A, D, F, and N may be selected and provided to first arbitrary function 320.

In step 430, the first arbitrary function (ƒ₁) is applied to the set of fields. As described above, the first arbitrary function may be, for example, a CRC (e.g., CRC16, CRC32, or CRCXX), FNV, or mapping table. The output of the function is provided as a seed index to seed selection module 330.

In step 440, the seed index is used by the seed selection module to select one or more seeds from the set of seed values 345 stored in memory 340.

In step 450, the selected one or more seeds are provided as input to a second arbitrary function. In this step, one or more fields from the data packet are also provided as input to the second arbitrary function. For example, fields A, D, E, and N may be provided to the second arbitrary function. In an embodiment, the set of fields selected and provided to the second arbitrary function is different than the set of fields provided to the first arbitrary function. In other embodiments, the same set of fields is provided to the first and second arbitrary functions.

In step 460, the second arbitrary function generates a hash value as output. In an embodiment, the hash value is a set of seeds. In an alternative embodiment, the hash value is a hash key.

In step 470, the output of the second arbitrary function (hash value) is provided as input to a member selection function. The member selection function selects the next-hop/link to which the packet should be forwarded. The member selection function can be any arbitrary function that maps the hash input value to an aggregate member. In an embodiment, the member selection function is hash function. In an alternate embodiment, the member selection function is a modulo function.

The randomization described above is based on attributes available in a packet which are fixed (not based on external process). An advantage of this approach is that it enables per flow randomization attributes based on per packet attributes to perform aggregate member selection while remaining deterministic from a root-node or network perspective. Another advantage of the techniques described herein is that these techniques are network topology independent and may be implemented in a wide range of network topologies including networks within a network to improve data traffic distribution and network efficiency.

The method of FIG. 4, described above, may be performed by one or more processors executing a computer program product. Additionally, or alternatively, one or all components of the method of FIG. 4 may be performed by special purpose logic circuitry such as a field programmable gate array (FPGA) or an application specific integrated circuit (ASIC).

FIG. 5 illustrates an example computer system 500 in which embodiments of the present invention, or portions thereof, can be implemented as computer-readable code. For example, the method illustrated by flowchart 400 can be implemented in system 500. However, after reading this description, it will become apparent to a person skilled in the relevant art how to implement embodiments using other computer systems and/or computer architectures.

Computer system 500 includes one or more processors, such as processor 506. Processor 506 can be a special purpose or a general purpose processor. Processor 506 is connected to a communication infrastructure 504 (for example, a bus or network).

Computer system 500 also includes a main memory 508 (e.g., random access memory (RAM)) and secondary storage devices 510. Secondary storage 510 may include, for example, a hard disk drive 512, a removable storage drive 514, and/or a memory stick. Removable storage drive 514 may comprise a floppy disk drive, a magnetic tape drive, an optical disk drive, a flash memory, or the like. Removable storage drive 514 reads from and/or writes to a removable storage unit 516 in a well-known manner Removable storage unit 516 may comprise a floppy disk, magnetic tape, optical disk, etc. which is read by and written to by removable storage drive 514. As will be appreciated by persons skilled in the relevant art(s), removable storage unit 516 includes a computer usable storage medium 524A having stored therein computer software and/or logic 520B.

Computer system 500 may also include a communications interface 518. Communications interface 518 allows software and data to be transferred between computer system 500 and external devices. Communications interface 518 may include a modem, a network interface (such as an Ethernet card), a communications port, a PCMCIA slot and card, or the like. Software and data transferred via communications interface 518 are in the form of signals which may be electronic, electromagnetic, optical, or other signals capable of being received by communications interface 518. These signals are provided to communications interface 518 via a communications path 528. Communications path 528 carries signals and may be implemented using wire or cable, fiber optics, a phone line, a cellular phone link, an RF link or other communications channels.

In this document, the terms “computer usable medium” and “computer readable medium” are used to generally refer to media such as removable storage unit 516 and a hard disk installed in hard disk drive 512. Computer usable medium can also refer to memories, such as main memory 508 and secondary storage devices 510, which can be memory semiconductors (e.g. DRAMs, etc.).

Computer programs (also called computer control logic) are stored in main memory 508 and/or secondary storage devices 510. Computer programs may also be received via communications interface 518. Such computer programs, when executed, enable computer system 500 to implement embodiments of the present invention as discussed herein. In particular, the computer programs, when executed, enable processor 506 to implement the processes of the present invention. Where embodiments are implemented using software, the software may be stored in a computer program product and loaded into computer system 500 using removable storage drive 514, interface 518, or hard drive 512.

Embodiments have been described above with the aid of functional building blocks illustrating the implementation of specified functions and relationships thereof The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of embodiments of the present invention should not be limited by any of the above-described exemplary embodiments, but should be defined only in accordance with the following claims and their equivalents.

What is claimed is:

1. A method for improving hash performance in a network device, comprising:
receiving, at the network device, a data packet having a plurality of fields;
selecting a first set of fields from the data packet;
generating a seed index based on the first set of fields using a first arbitrary function;
selecting a seed value from a set of seed values based on the seed index;
generating a hash input value based on the seed value and a second set of fields from the data packet using a second arbitrary function; and
generating an output based on the hash input value using a third arbitrary function.

2. The method of claim 1, wherein the output is used to select a path in a plurality of paths for transmitting the data packet.

3. The method of claim 1, wherein the first arbitrary function is a cyclic redundancy check.

4. The method of claim 1, wherein the first arbitrary function is a mapping table.

5. The method of claim 1, wherein the first arbitrary function is different than the second arbitrary function.

6. The method of claim 1, wherein the second arbitrary function is an XOR hash.

7. The method of claim 1, wherein the third arbitrary function is a hash function.

8. The method of claim 1, wherein the third arbitrary function is a modulo function.

9. The method of claim 1, further comprising:
prior to receiving a data packet, storing the set of seed values in a memory in the network device.

10. The method of claim 1, further comprising:
prior to receiving the data packet, generating the set of seed values.

11. A computer program product comprising a non-transitory computer useable medium having computer program logic recorded thereon, the computer control logic when executed by a processor enabling the processor to process packet data according to a method, the method comprising:
selecting a first set of fields from a received data packet;
generating a seed index based on the first set of fields using a first arbitrary function;
selecting a seed value from a set of seed values based on the seed index;
generating a hash input value based on the seed value and a second set of fields from the data packet using a second arbitrary function;
generating an output based on the hash input value using a third arbitrary function; and
selecting a path in a plurality of paths for transmitting the data packet.

12. The computer program product of claim 11, wherein the first arbitrary function is a cyclic redundancy check.

13. The computer program product of claim 11, wherein the first arbitrary function is a mapping table.

14. The computer program product of claim 11, wherein the first arbitrary function is different than the second arbitrary function.

15. The computer program product of claim 11, wherein the second arbitrary function is an XOR hash.

16. The computer program product of claim 11, wherein the third arbitrary function is a hash function.

17. The computer program product of claim 11, wherein the third arbitrary function is a modulo function.

18. The computer program product of claim 11, further comprising:
prior to receiving a data packet, storing the set of seed values in a memory in the network device.

19. The computer program product of claim 11, further comprising:
prior to receiving the data packet, generating the set of seed values
